(19) United States
(12) Patent Application Publication
(10) Pub. No.: US 2003/0050864 A1
(43) Pub. Date: Mar. 13, 2003

(54) On-line method for aiding a customer in the purchase of clothes

(75) Inventors: Miroslav Trajkovic, Ossining, NY (US); Vasanth Philomin, Briarcliff Manor, NY (US); Srinivas Gutta, Buchanan, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/951,867

(22) Filed: Sep. 13, 2001

(51) Int. Cl. G06F 17/60

(52) U.S. Cl. 705/27

(57) ABSTRACT

A method for aiding a customer in the purchase of clothes on-line. The method including: accessing an Internet web site for the purchase of clothes, the Internet web site having a three-dimensional model of at least one style and size of clothes displayed thereon; providing a three-dimensional model of the customer; selecting the at least one style and size of clothes displayed at the Internet web site; generating a virtual three-dimensional model of the customer wearing the at least one style and size of clothes selected; and displaying the virtual three-dimensional model to the customer.

### BACKGROUND OF THE INVENTION

1. Field of the Invention

The present invention relates generally to an on-line method for aiding a customer in the purchase of clothes, and more particularly, to an on-line method for purchasing clothes in which a customer can virtually try on the clothes on a three-dimensional model of the customer to determine their fit and look.

2. Prior Art

The amount of sales of goods over the Internet has exploded in recent years. Many consumers who would have never thought of purchasing goods over the Internet are now doing their shopping on-line. However, even though sales over the Internet are increasing at significant rates, sales over the Internet account for a very small portion of the overall sales of goods.

Many people feel that one of the reasons for the low percentage of overall sales being done on-line is because consumers cannot “kick the tires” of the goods they wish to purchase on-line. In other words, consumers like to see and touch goods that they are purchasing.

This concept is perhaps the strongest where the goods are clothes. Consumers not only like to touch and see the clothes that they are buying but they like to try them on for size and to see how they look on their particular body shape and size. People also like to see how clothes look and fit from different viewing angles, such as from behind, or while in certain positions, such as while sitting, or while performing certain actions, such as walking.

### SUMMARY OF THE INVENTION

Therefore it is an object of the present invention to provide a method for the on-line sale of clothes, which allows a user to see the fit of the clothes on their particular body shape and size.

It is another object of the present invention to provide a method for the on-line sale of clothes, which allows a user to see the fit of the clothes on their particular body shape and size from various viewing angles.

It is yet another object of the present invention to provide a method for the on-line sale of clothes, which allows a user to see the fit of the clothes on their particular body shape and size while in different positions.

It is still yet another object of the present invention to provide a method for the on-line sale of clothes, which allows a user to see the fit of the clothes on their particular body shape and size while performing different actions.

Accordingly, a method for aiding a customer in the purchase of clothes on-line is provided. The method comprises: accessing an Internet web site for the purchase of clothes, the Internet web site having a three-dimensional model of at least one style and size of clothes displayed thereon; providing a three-dimensional model of the customer; selecting the at least one style and size of clothes displayed at the Internet web site; generating a virtual three-dimensional model of the customer wearing the at least one style and size of clothes selected; and displaying the virtual three-dimensional model to the customer.

The virtual three-dimensional model is preferably displayed from a predetermined viewing angle, and the method further comprises manipulating the displayed virtual three-dimensional model such that it can be viewed from at least one other viewing angle. Additionally, the virtual three-dimensional model is preferably displayed in a predetermined position, and the method further comprises manipulating the displayed virtual three-dimensional model such that it can be displayed into at least one other position. Furthermore, the virtual three-dimensional model is preferably displayed in a predetermined action, and the method further comprises manipulating the displayed virtual three-dimensional model such that it can be displayed in at least one other action.

Preferably, the providing step comprises: capturing three-dimensional digital image data of the customer; generating the three-dimensional model of the customer from the captured digital image data; storing the three-dimensional model of the customer at an Internet server; and retrieving the stored three-dimensional model of the customer from the Internet server to the Internet web site. Prior to the retrieving step the method preferably further comprises: assigning a unique password to the customer corresponding to the stored three-dimensional model of the customer; and entering the unique password, which if correct, provides access for retrieval of the stored three-dimensional model.

The method preferably also further comprises purchasing the at least one style and size of clothes.

Also provided is a system for aiding a customer in the purchase of clothes on-line. The system comprises: means for accessing an Internet web site for the purchase of clothes, the Internet web site having a three-dimensional model of at least one style and size of clothes displayed thereon; means for providing a three-dimensional model of the customer; means for selecting the at least one style and size of clothes displayed at the Internet web site; means for generating a virtual three-dimensional model of the customer wearing the at least one style and size of clothes selected; and a display for displaying the virtual three-dimensional model to the customer.

The virtual three-dimensional model is preferably displayed from a predetermined viewing angle, and the system further comprises means for manipulating the displayed virtual three-dimensional model such that it can be viewed from at least one other viewing angle. Additionally, the virtual three-dimensional model is preferably displayed in a predetermined position, and the system further comprises means for manipulating the displayed virtual three-dimensional model such that it can be displayed into at least one other position. Furthermore, the virtual three-dimensional model is preferably displayed in a predetermined action, the system further comprises means for manipulating the displayed virtual three-dimensional model such that it can be displayed in at least one other action.

The means for providing preferably comprises: at least two cameras for capturing three-dimensional digital image data of the customer; a computer vision system for generating the three-dimensional model of the customer from the captured digital image data; a memory for storing the three-dimensional model of the customer at an Internet server; and means for retrieving the stored three-dimensional model of the customer from the Internet server to the Internet web site.

Preferably, the system further comprises: means for entering a unique password, which if correct, provides access for retrieval of the stored three-dimensional model.

The system preferably further comprises means for purchasing the at least one style and size of clothes.

Still yet provided are a computer program product for carrying out the methods of the present invention and a program storage device for the storage of the computer program product therein.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a flowchart showing the preferred steps of the methods of the present invention.

FIG. 2 illustrates a schematic representation of a system for carrying out a preferred implementation of the methods of FIG. 1.

FIG. 3 illustrates a schematic representation of an alternative system for carrying out the methods of the present invention.

### DETAILED DESCRIPTION OF THE PREFERRED EMBODIMENT

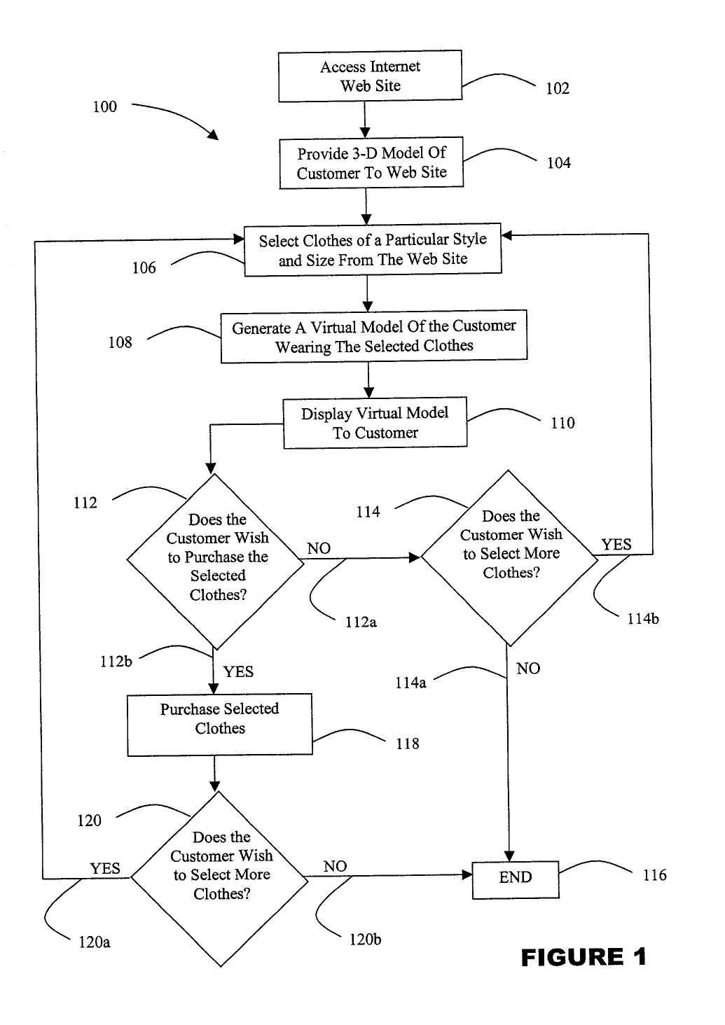

Referring now to FIG. 1, there is illustrated a preferred method of the present invention for aiding a customer in the purchase of clothes on-line, the method being generally referred to by reference numeral 100. At step 102 an Internet web site for the purchase of clothes is accessed. The Internet web site has a three-dimensional model of at least one style and size of clothes displayed thereon. Preferably, the Internet web site has three-dimensional models for each of a plurality of different styles of clothing, such as pants, shirts, dresses, undergarments, coats, and the like. Furthermore, for each of the plurality of styles of clothes, a three-dimensional model is available for each of a plurality of different sizes. Methods for modeling clothes are well known in the art, such as that disclosed in Jojic et al., On Analysis of cloth Drape Range Data, Third Asian Conference on Computer Vision (ACCV), Hong Kong, China, January 1998.

At step 104 a three-dimensional model of the customer is provided. Preferably, the three dimensional model of the customer is provided by first capturing three-dimensional digital image data of the customer with at least two cameras. Next, a three-dimensional model of the customer is generated from the captured digital image data. Subsequent to the generation of the three-dimensional model of the customer, the same is preferably stored at an Internet server or saved in memory at the customer's computer system. After being stored at the server, the three-dimensional model of the customer can be retrieved from the Internet server to the Internet web site or retrieved by the customer's computer system. While at the web site, the customer can enter a unique password, assigned to him or her and corresponding to their stored three-dimensional model. If the password is entered correctly, access for retrieval of the stored three-dimensional model is granted and the web site retrieves the three-dimensional model of the customer for use in the subsequent steps discussed below.

At step 106, at least one style and size of clothes displayed at the Internet web site is selected by the customer. The different styles and sizes can be provided at the web site in any number of formats. Preferably, the different styles and sizes are simply listed and selected by clicking on the appropriate text in the list. The web site can also provide text boxes for filling in the style and size clothes to be selected by the customer. Further, the web site can show the styles and/or sizes of clothes graphically, by thumbnails of the style of clothes. Clicking on the appropriate thumbnail selects the style and size of clothes for use in subsequent steps. Any combination of the means for selecting discussed above can also be used. More than one style of clothes can be selected for use in the subsequent steps of the method. For instance, the customer can select pants of a certain size and a shirt of a certain size. The term “clothes” as used herein is also intended to include headwear such as hats, footwear such as socks and shoes, and accessories, such as a scarf or belt.

At step 108, a virtual three-dimensional model of the customer wearing the at least one style and size of clothes selected is generated. The method merges the three-dimensional model of the customer with the three-dimensional model of the style and size clothes selected to generate the virtual three-dimensional model of the customer wearing the selected clothes. Means for generating the virtual model of the customer wearing the selected clothes are well known in the art, such as that disclosed in Jojic et al., On Analysis of cloth Drape Range Data, Third Asian Conference on Computer Vision (ACCV), Hong Kong, China, January 1998.

At step 110, the virtual three-dimensional model is displayed to the customer. The virtual three-dimensional model is preferably initially displayed from a predetermined viewing angle, such as a frontal view or preferably a frontal/side view which shows mostly the front of the virtual three-dimensional model and a small amount of its side. After the initial display, the displayed virtual three-dimensional model can be thereafter manipulated such that it can be viewed from at least one other viewing angle, such as from the rear. Similarly, the virtual three-dimensional model is preferably initially displayed in a predetermined position, such as a standing position. After the initial display, the displayed virtual three-dimensional model can also be manipulated such that it can be displayed into at least one other position, such as a sitting or bending position. Furthermore, the virtual three-dimensional model is preferably initially displayed in a predetermined action, such as being still. After the initial display, the displayed virtual three-dimensional model can be manipulated such that it can be displayed in at least one other action, such as walking. Methods for manipulating and animating the display of a three-dimensional object are well known in the art.

At step 112, it is determined by the customer whether or not he or she wishes to purchase the selected clothes, based at least in part on the display of the virtual three-dimensional model wearing the selected clothes. If the customer does not wish to purchase the selected clothes, the method 100 continues along path 112a where it is determined if the customer would like to select any other clothes at step 114. If the customer does not want to select any other clothes, the method continues along path 114a and ends at step 116. If the customer does wish to select additional clothes, the method continues along path 114b and loops back to step 106 where other styles and sizes of clothes can be selected.

If the customer does wish to purchase the selected clothes, the method proceeds along path 112b to step 118 where the customer purchases the selected clothes. Preferably, the purchase of the clothes is done on-line at the web site. Purchasing of goods on-line is well known in the art. After purchasing the selected clothes, it is again determined if the customer would like to select more clothes at step 120. If the customer does wish to select more clothes, the method 100 proceeds along path 120a and loops back to step 106 where other styles and sizes of clothes can be selected. If the customer does not desire to select more clothes, the method 100 continues along path 120b and ends at step 116.

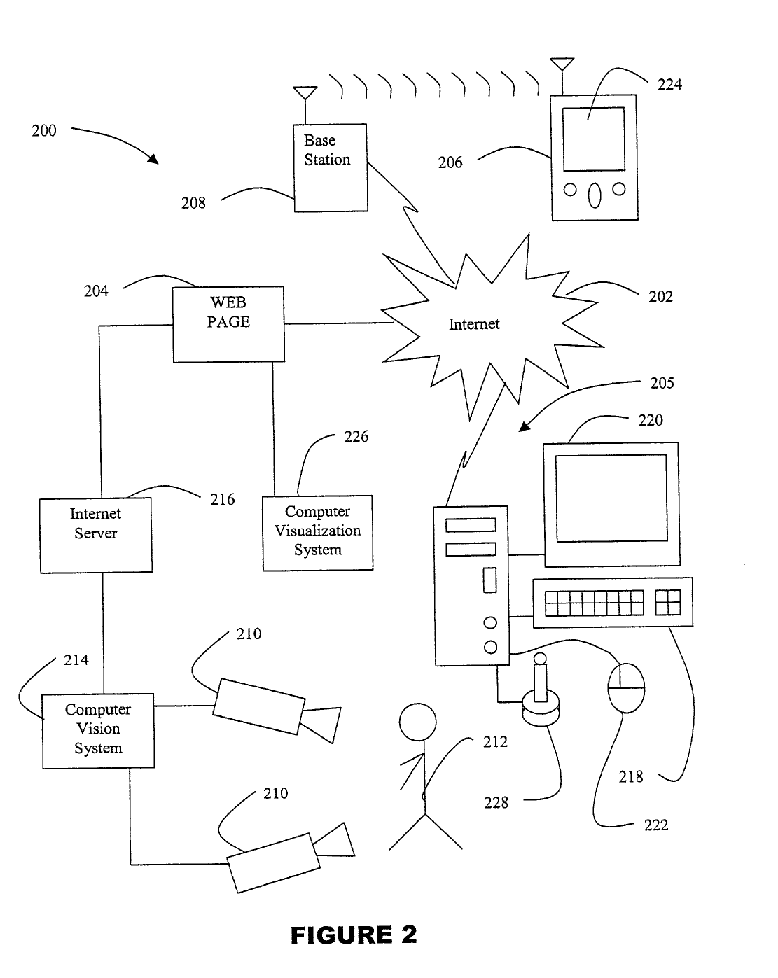

A first embodiment of a system for carrying out the methods of the present invention will now be described with reference to FIG. 2. The system illustrated in FIG. 2 being generally referred to by reference numeral 200. System 200 includes a means for accessing the Internet 202 and an Internet web site 204 for the purchase of clothes. As described above, the internet web site 204 has at least one and preferably a plurality of three-dimensional models of styles and sizes of clothes displayed thereon. The means for accessing the Internet web site preferably comprises a computer system 205 having a modem or other means for accessing the Internet. The means for accessing the Internet web site can also be a wireless device 206, such as a laptop computer, a personal digital assistant (PDA), or a cellular phone which access the Internet 202 through a wireless link with a base station 208.

The system also includes a means for providing a three-dimensional model of the customer to the Internet web site 204. The means for providing the three-dimensional model preferably comprises at least two cameras 210 for capturing three-dimensional image data of the customer 212. The cameras 210 are preferably digital cameras. Alternatively, the cameras 210 are analog cameras, in which case an analog to digital converter (not shown) is necessary to convert the analog data to digital data for subsequent processing by the system 200. A computer vision system 214 generates a three-dimensional model of the customer 212 from the captured image data. Preferably, the generated model of the customer 212 is stored at an Internet server 216. The stored three-dimensional model of the customer is preferably retrieved from the Internet server 216 to the Internet web site 204 by entering a unique password, which if correct, provides access for retrieval of the stored three-dimensional model. The password can be entered by any means known in the art, preferably, by entering an alpha-numeric designation using the keys of a keyboard 218 connected to the computer system 205 or by depressing keys on the wireless communication device 206. Alternatively, the system 200 can browse the memory of the computer system 205 or wireless communication device 206 on which the three-dimensional model of the customer 212 is stored and upload the same for access by the Internet web site 204.

The generation of the three-dimensional model of the customer need only be done once and then stored for further use, either locally at computer system 205 or at the Internet server 216. However, the three-dimensional model should be updated if the customer should lose or gain weight so as to change his or her body shape or if for any other reason there is a change in body shape or size. The generation of the three-dimensional model of the customer can also be done “on the fly” while the customer is at the web site 204, in which case the cameras 210 and computer vision system 214 are operatively connected to the computer system 205 and the generated three-dimensional model of the customer is uploaded to the web site 204 from the computer system 205. As discussed above, generation of both three-dimensional models for clothes and humans are well known in the art.

System 200 also includes a means for selecting the at least one style and size of clothes displayed at the Internet web site 204. As discussed above, the plurality of clothes styles and sizes can be presented on the web site 204 in a number of ways. Where the styles and sizes are presented by way of a simple list (either textual or graphical), on a monitor 220, any entry in the list can preferably be selected by the keyboard 218 (e.g., by using the arrow, tab, and/or enter keys) or preferably with a pointing device such as a mouse 222 or by touching the corresponding portion of a touch screen 224. Where text boxes are used to enter the style and/or size of clothes to be selected, the keyboard 218 is preferably used to enter the appropriate alpha-numeric data.

System 200 also includes a means for generating a virtual three-dimensional model of the customer wearing the at least one style and size of clothes selected, such as a computer visualization system 226. As discussed above, means for merging three-dimensional models of a human and clothes to generate a virtual model of the human wearing the clothes are well known in the art. The virtual three-dimensional model of the customer 212 is then displayed on the monitor 220, the touch screen 224, or other display.

As discussed above, the virtual three-dimensional model is initially displayed from a predetermined viewing angle, a predetermined position, and performing a predetermined action. The system includes means for manipulating the displayed virtual three-dimensional model such that it can be viewed from at least one other viewing angle, in one other position, and/or performing one other action. The means for manipulating the displayed virtual three-dimensional model preferably comprises a joystick 228 to rotate the displayed model about any one of three axes. Alternatively, the keyboard 218 or mouse 22 can also be used to manipulate the viewing angle of the displayed virtual three-dimensional model. To manipulate the position and action of the displayed virtual three-dimensional model, buttons are preferably displayed on the web site 204 each corresponding to predetermined positions (e.g., standing, sitting, and bending) and actions (e.g., standing still, walking, running, jumping). Clicking on any one of the buttons with mouse 222 would cause the virtual three-dimensional model to be manipulated accordingly. Manipulation of the viewing angle, position, and animation of three-dimensional models is well known in the art.

System 200 further comprises means for purchasing the at least one style and size of clothes selected. Preferably, the selected clothes are purchased by clicking on an appropriate button on the web site 204 or by designating the clothes to add to a virtual “shopping cart.” Methods for purchasing goods on-line, particularly by filling a virtual “shopping cart” are well known in the art and may or may not involve using a credit card for the purchase.

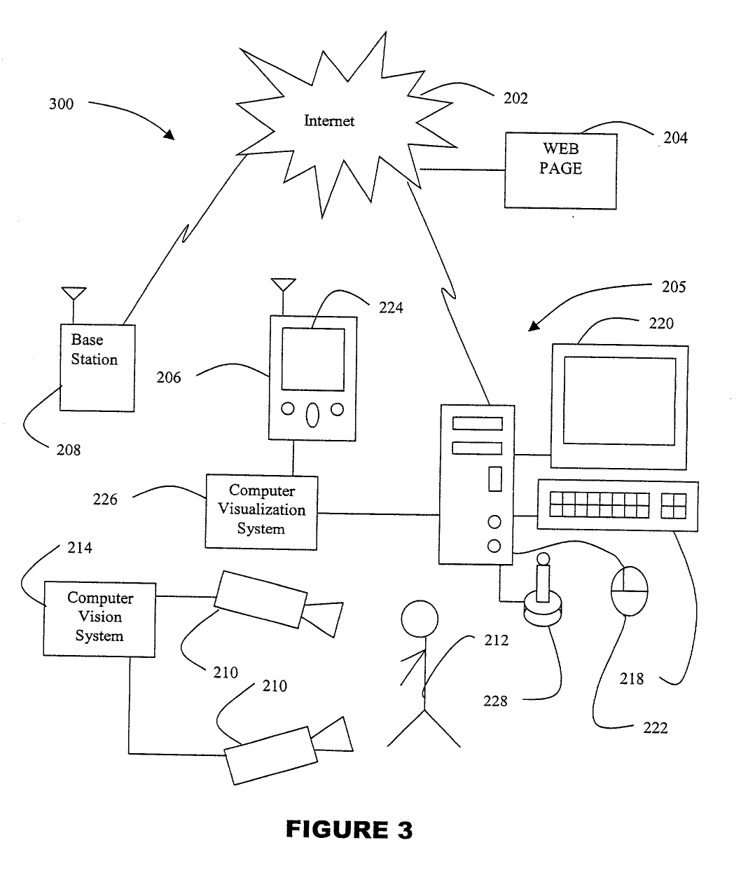

Referring now to FIG. 3, there is illustrated an alternative embodiment of a system for aiding a customer in the purchase of clothes on-line, the alternative system being referred to by reference numeral 300. The system 200 discussed above with regard to FIG. 2, assumes that the generation of the virtual three-dimensional model of the customer wearing the selected clothes takes place at the web site 204 or a server connected thereto. In the alternative embodiment illustrated in FIG. 3, system 300 generates the virtual three-dimensional model of the customer wearing the selected clothes locally, for instance, at the computer system 205 or wireless device 206. In such a situation, the computer system 205 would have access to the three-dimensional model of the customer, such as it being stored on a peripheral device connected to or integral therewith, or directly from cameras 210 and computer vision system 214. In system 300, the computer visualization system 226 is contained on or coupled with the computer system 205.

The operation of the system of FIG. 3 is similar to that of system 200 illustrated in FIG. 2. In system 300, the customer accesses the Internet web site 204 and selects predetermined styles and sizes of clothes. Three-dimensional models of the selected styles and sizes of clothes are downloaded or streamed to the computer system 205 or wireless communication device 206. The computer system 205 or wireless communication device 206 then accesses the three-dimensional model of the customer and generates the virtual three-dimensional model of the customer wearing the selected clothes from both the three-dimensional model of the customer and the three-dimensional model(s) of the selected clothes. The virtual three-dimensional model of the customer wearing the selected clothes is then displayed to the customer, preferably, on monitor 220 or screen 224. The customer can then decide whether or not to purchase the selected clothes, try on different clothes, or quit, as discussed above.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for aiding a customer in the purchase of clothes on-line, the method comprising:
accessing an Internet web site for the purchase of clothes, the Internet web site having a three-dimensional model of at least one style and size of clothes displayed thereon;
providing a three-dimensional model of the customer;
selecting the at least one style and size of clothes displayed at the Internet web site;
generating a virtual three-dimensional model of the customer wearing the at least one style and size of clothes selected; and
displaying the virtual three-dimensional model to the customer.

2. The method of claim 1, wherein the virtual three-dimensional model is displayed from a predetermined viewing angle, the method further comprising manipulating the displayed virtual three-dimensional model such that it can be viewed from at least one other viewing angle.

3. The method of claim 1, wherein the virtual three-dimensional model is displayed in a predetermined position, the method further comprising manipulating the displayed virtual three-dimensional model such that it can be displayed into at least one other position.

4. The method of claim 1, wherein the virtual three-dimensional model is displayed in a predetermined action, the method further comprising manipulating the displayed virtual three-dimensional model such that it can be displayed in at least one other action.

5. The method of claim 1, wherein the providing step comprises:
capturing three-dimensional digital image data of the customer;
generating the three-dimensional model of the customer from the captured digital image data;
storing the three-dimensional model of the customer at an Internet server; and
retrieving the stored three-dimensional model of the customer from the Internet server to the Internet web site.

6. The method of claim 5, further comprising prior to the retrieving step:
assigning a unique password to the customer corresponding to the stored three-dimensional model of the customer; and
entering the unique password, which if correct, provides access for retrieval of the stored three-dimensional model.

7. The method of claim 1, further comprising purchasing the at least one style and size of clothes.

8. A system for aiding a customer in the purchase of clothes on-line, the system comprising:
means for accessing an Internet web site for the purchase of clothes, the Internet web site having a three-dimensional model of at least one style and size of clothes displayed thereon;
means for providing a three-dimensional model of the customer;
means for selecting the at least one style and size of clothes displayed at the Internet web site;
means for generating a virtual three-dimensional model of the customer wearing the at least one style and size of clothes selected; and
a display for displaying the virtual three-dimensional model to the customer.

9. The system of claim 8, wherein the virtual three-dimensional model is displayed from a predetermined viewing angle, the system further comprising means for manipulating the displayed virtual three-dimensional model such that it can be viewed from at least one other viewing angle.

10. The system of claim 8, wherein the virtual three-dimensional model is displayed in a predetermined position, the system further comprising means for manipulating the displayed virtual three-dimensional model such that it can be displayed into at least one other position.

11. The system of claim 8, wherein the virtual three-dimensional model is displayed in a predetermined action, the system further comprising means for manipulating the displayed virtual three-dimensional model such that it can be displayed in at least one other action.

12. The system of claim 8, wherein the means for providing comprises:
at least two cameras for capturing three-dimensional digital image data of the customer;
a computer vision system for generating the three-dimensional model of the customer from the captured digital image data;
a memory for storing the three-dimensional model of the customer at an Internet server; and
means for retrieving the stored three-dimensional model of the customer from the Internet server to the Internet web site.

13. The system of claim 12, further comprising:
means for entering a unique password, which if correct, provides access for retrieval of the stored three-dimensional model.

14. The system of claim 8, further comprising means for purchasing the at least one style and size of clothes.

15. A program storage device readable by machine, tangibly embodying a program of instructions executable by the machine to perform method steps for aiding a customer in the purchase of clothes on-line, the method comprising:
accessing an Internet web site for the purchase of clothes, the Internet web site having a three-dimensional model of at least one style and size of clothes displayed thereon;
providing a three-dimensional model of the customer;
selecting the at least one style and size of clothes displayed at the Internet web site;
generating a virtual three-dimensional model of the customer wearing the at least one style and size of clothes selected; and
displaying the virtual three-dimensional model to the customer.

16. A computer program product embodied in a computer-readable medium for aiding a customer in the purchase of clothes on-line, the computer program product comprising:
computer readable program code means for accessing an Internet web site for the purchase of clothes, the Internet web site having a three-dimensional model of at least one style and size of clothes displayed thereon;
computer readable program code means for providing a three-dimensional model of the customer;
computer readable program code means for selecting the at least one style and size of clothes displayed at the Internet web site;
computer readable program code means for generating a virtual three-dimensional model of the customer wearing the at least one style and size of clothes selected; and
computer readable program code means for displaying the virtual three-dimensional model to the customer.
